(19) United States
(12) Patent Application Publication
(10) Pub. No.: US 2006/0048204 A1
(43) Pub. Date: Mar. 2, 2006

(54) Method of storing a stream of audiovisual data in a memory

(75) Inventor: Keith Baker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTROINCS N.V., EINDHOVEN (NL)

(21) Appl. No.: 10/526,922

(22) PCT Filed: Aug. 18, 2003
(86) PCT No.: PCT/IB03/03661

§ 371 Date: Mar. 8, 2005

(30) Foreign Application Priority Data
Sep. 13, 2002 (EP) 02078780.0

(51) Int. Cl. H04N 7/173; H04N 7/16

(52) U.S. Cl. 725/134; 725/142; 725/89

(57) ABSTRACT

The invention relates to a method of splitting up (220) a stream of audiovisual data into a stream of audio data and a stream of video data and of storing (225) at least the audio data when the content of the stream of audiovisual data matches (210) at least one criterion (215). As additional information, one or few frames of video information may be stored as well so as to provide a user, during reproduction of the audio data, with additional information on the content of the video data stream.

The invention relates to a method of storing a stream of audiovisual data in a memory, the method comprising the steps of determining the content of the stream of audiovisual data, and determining whether the content of the stream of audiovisual data matches at least one predetermined criterion.

The invention also relates to an apparatus adapted to store at least a part of a stream of audiovisual data in a memory, the apparatus being further adapted to determine the content of the stream of audiovisual data, and determine whether the content of the stream of audiovisual data matches at least one predetermined criterion.

The invention also relates to a record carrier comprising instructions which can be carried out by a processor.

Embodiments of such a method and such an apparatus are known from U.S. Pat. No. 6,088,455. This document describes an apparatus in which identification signals of a television program are stored. A television signal is received by the apparatus. This television signal is compared with the identification signals. If a segment of the television signal comprises the identification signal, all audiovisual data of the relevant segment are stored in the apparatus.

It is an object of the invention to use the memory more efficiently.

This object is achieved by means of the method according to the invention, which method is characterized in that, if the content of the stream of audiovisual data matches the predetermined criterion, the method further comprises the steps of: separating the audio data and video data in the stream of audiovisual data; storing at least a substantial part of the audio data of the stream of audiovisual data; and storing at most a part of the video signal.

The invention is based on the recognition that, in a considerable number of cases, it is not necessary to store all data. Some programs such as talk shows and music transmitted, for example, by music stations can also be followed satisfactorily without video information. Instead of storing all audiovisual data, only the sound information could be stored so as to be able to follow the program at a later point of time. Since video data occupy a considerably larger memory space than audio data, much memory space is gained when only the audio data are stored.

An embodiment of the method according to the invention is characterized in that the method further comprises the step of storing a part of the video data of the stream of audiovisual data, in which the stored part is substantially smaller than the complete video component of the stream of audiovisual data.

An advantage of this embodiment is that a certain quantity of video data can also be presented when playing back the audio data. In this way, a user can be provided with extra information about the stream of audiovisual data when playing back the stored audio information, while less data is still stored than in the case where the complete stream of audiovisual data would be stored. The video data may comprise little information but nevertheless it may be particularly useful to supply a user with this information.

An embodiment of the method according to the invention, in which the video component of the stream of audiovisual data is built up of frames is characterized in that the step of storing a part of the video data comprises the step of periodically storing a frame.

An advantage of such an embodiment is that a user can be informed at fixed points of time of developments in the video data of the stream of audiovisual information when playing back the stored audio information. In a talk show, the video data generally comprises little information, but by supplying a user with images at certain points of time, this user knows what persons are talking. This may be very relevant information.

An embodiment of the method according to the invention, in which the video component of the stream of audiovisual data is built up of frames is characterized in that the step of storing a part of the video data comprises the step of storing the first frame of the stream of audiovisual data.

An advantage of such an embodiment is that the first frame of the stream may be a title page. This title page may be displayed on a screen for the purpose of information when reproducing the stored audio data.

An embodiment of the method according to the invention, in which the video component of the stream of audiovisual data is built up of frames, is characterized in that the step of storing a part of the video data comprises the sub-steps of: determining a characteristic feature of a first part of the stream of audiovisual data; determining a characteristic feature of a second part of the stream of audiovisual data; determining the difference between the characteristic feature of the first part and the characteristic feature of the second part; and, if the difference is larger than a predetermined minimum, storing a frame of the first part of the stream of audiovisual data.

An advantage of such a method is that the video data is stored at moments when the stream of audiovisual information comprises much information. However, if the stream of audiovisual information comprises no or little information, only the audio data of the stream of audiovisual data is stored. In this way, a maximum quantity of relevant information is stored, while the memory is being used efficiently.

The apparatus according to the invention is characterized in that the apparatus is further adapted to separate the audio data and video data in the stream of audiovisual data and comprises a memory for storing at least a substantial part of the audio data of the stream of audiovisual data if the content of the stream of audiovisual data matches the predetermined criterion.

The record carrier according to the invention is characterized in that the instructions enable the processor to perform the method as defined in claim 1.

These and other aspects of the invention are apparent from and will be elucidated with reference to the embodiments described hereinafter.

In the drawings:

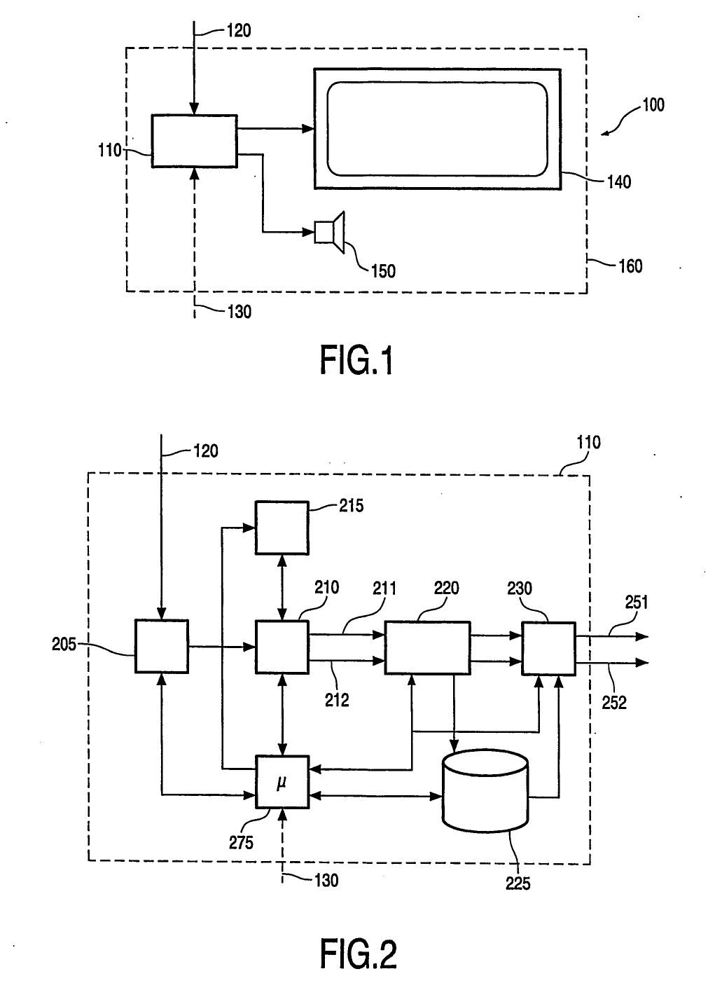

FIG. 1 shows an application of an embodiment of the apparatus according to the invention;

FIG. 2 shows an embodiment of the apparatus according to the invention;

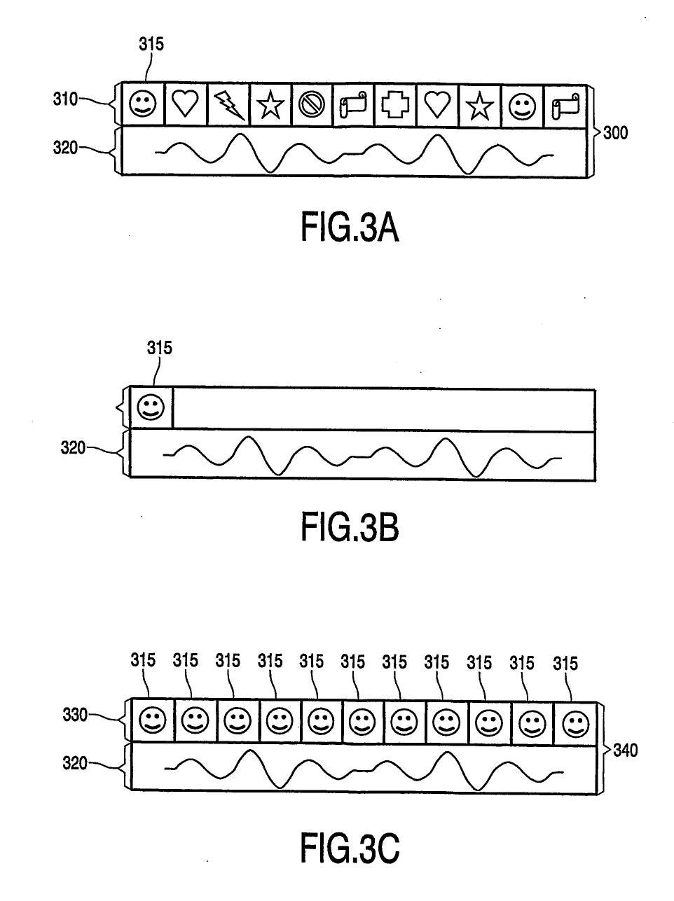

FIG. 3A shows a stream of information received by the apparatus according to the invention;

FIG. 3B shows information which is stored in accordance with an embodiment of the method according to the invention;

FIG. 3C shows a stream of information indicating how information, stored by means of an embodiment of the method according to the invention, is displayed;

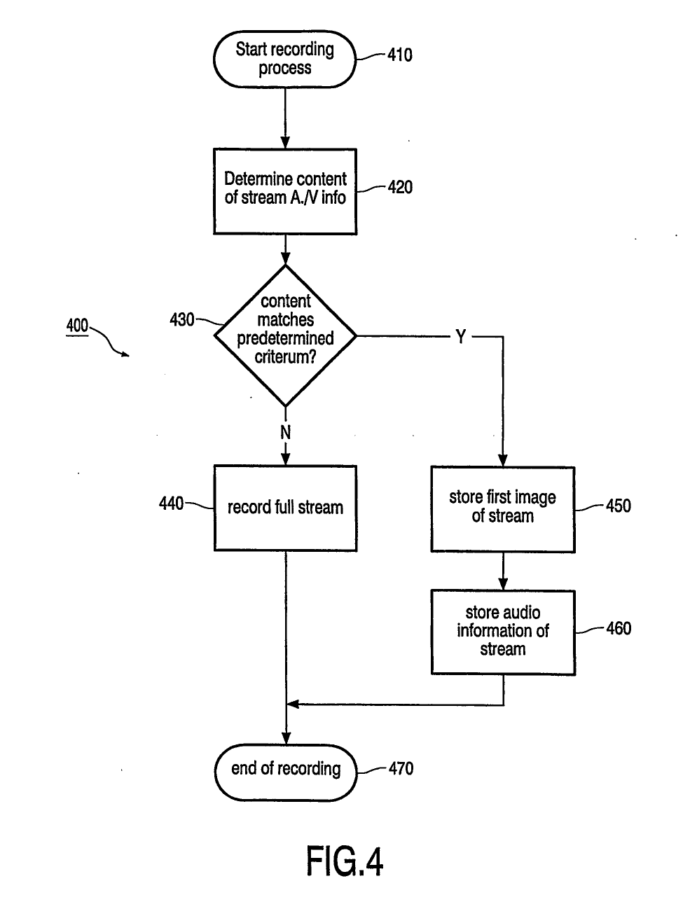

FIG. 4 shows a flow chart to illustrate an embodiment of the method according to the invention;

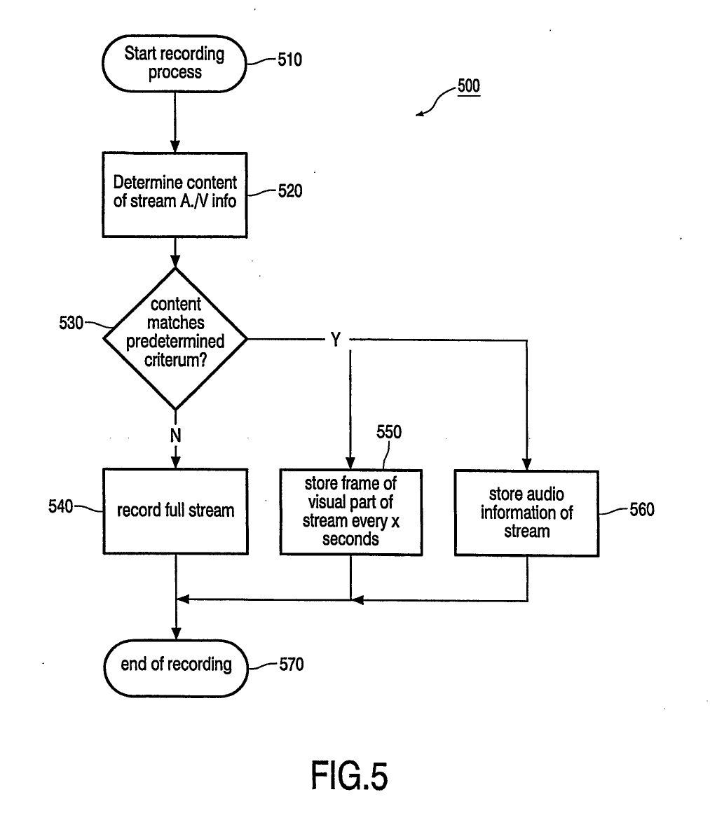

FIG. 5 shows a further flow chart to illustrate a further embodiment of the method according to the invention;

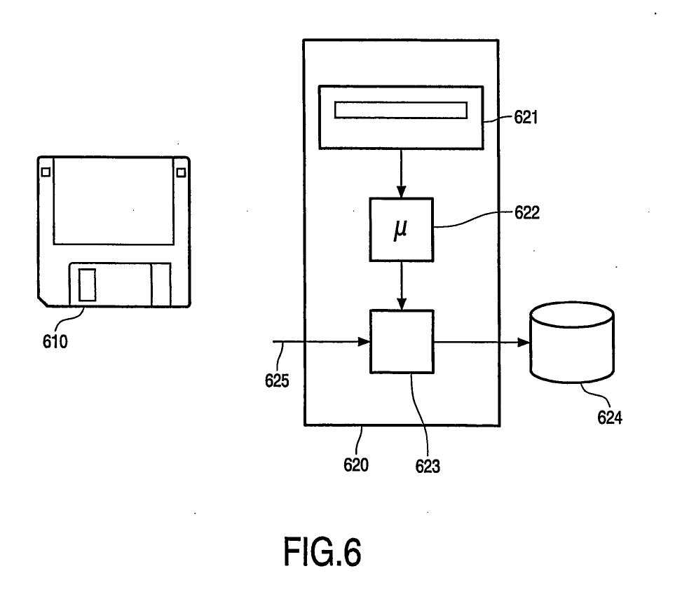

FIG. 6 shows an embodiment of the record carrier according to the invention.

FIG. 1 shows a system 100 for presenting and storing audiovisual information. The system 100 comprises a display screen 140, a loudspeaker 150 and an apparatus 110 as an embodiment of the apparatus according to the invention. The apparatus 110 receives an input signal 120, which is an RP antenna signal in the embodiment shown. The apparatus 110 is operated via a signal 130 by a user of the apparatus 110. This signal may be an IR signal, but also an electric signal, which is not relevant for the invention. The RF antenna signal comprises a stream of audiovisual information. The audiovisual information can be stored in the apparatus 110 and/or displayed/reproduced on the display screen 140/loudspeaker 150. Whether the stream of audiovisual information (or a part thereof) is stored in the apparatus 110 depends on the commands given by the user to the apparatus 110 via the signal 130.

In one embodiment of the invention, the apparatus 110, the display screen 140 and the loudspeaker are combined in a further apparatus 160.

FIG. 2 shows a more detailed drawing of the apparatus 110. The apparatus 110 comprises reception means 205 which receive the input signal 120. The reception means 205 convert the input signal 120 from an RF signal to a low-frequency signal which can be further processed by further components of the apparatus 110. The output of reception means 205 is a digital stream of audiovisual information in the embodiment shown. An output of the reception means 205 is coupled to identification means 210 which compare the content of the stream of audiovisual information with at least one reference criterion. The identification means 210 are coupled to a database 215 comprising reference criteria. The reference criteria are entered into the database by the user via the signal 130 which is received by the apparatus 110 via a central processing unit 275. The incoming reference criteria are entered into the database 215 from the central processing unit 275.

The content of the stream of audiovisual information can be compared in many ways known to those skilled in the art. For example, it is possible to describe the content of the stream of audiovisual information by means of meta data such as the MPEG-7 standard or the TV-Anytime standard. Alternatively, the database 215 may comprise EPG information and the identification means may identify the incoming stream of audiovisual information on the basis of the EPG information. This information may comprise the genre of the program (talk show, movie) and information about the further contents (talk show master, actors, guests, theme). This is relevant information, notably in the case of a TV program.

Moreover, it is also possible to determine the content of the stream of audiovisual information on the basis of the audiovisual information itself. Many programs have an introduction, also referred to as leader, which is identical for each episode. By storing its information about the introduction to a program in the database 215 and comparing the incoming stream of audiovisual information with the introduction with the aid of the identification means 210, the content of the program can be identified. Said examples are merely illustrative and it will be evident to those skilled in the art that there are many ways of identifying the contents of the program.

In a further embodiment of the apparatus according to the invention, the identification means 210 comprise classification means for first classifying the content of the incoming stream of audiovisual information and subsequently comparing the category of the stream of audiovisual information with criteria in the database 215.

The identification means 210 are coupled to splitting means 220. The identification means 210 send the stream of audiovisual information to the splitting means 220 via a connection 211 and a control signal via a connection 212. In this embodiment, the control signal is a binary signal indicating whether the content of the stream of audiovisual information matches or does not match the predetermined criteria.

If the content of the stream of audiovisual information matches the predetermined criteria, the splitting means 220 receive a positive signal from the identification means 210 via the connection 212. When the user has instructed the apparatus 110 to store the stream of audiovisual information or a part thereof in a memory 225, the stream of audiovisual information is split up into a first information stream, comprising the video information of the stream of audiovisual information, and a second information stream comprising the audio information of the stream of audiovisual information. This is shown in FIG. 3A.

FIG. 3A shows a stream of audiovisual information 300, a first information stream 310 comprising video information of the stream of audiovisual information and a second information stream 320 of the stream of audiovisual information.

After splitting the stream of audiovisual information 300, the second information stream 320—if the control signal of the connection 212 is positive—is stored in the memory 225 by means of an embodiment of the method according to the invention. The second information stream 320 can be compressed before it is stored.

In an embodiment of the invention, the first information stream 310 is built up of frames. If the user of the apparatus 110 has given the instruction that the stream of audiovisual information must be stored and if the control signal of the connection 212 is positive, only a first frame 315 of the first information stream 310 is stored in the memory 225 by means of an embodiment of the method according to the invention. FIG. 3B shows which parts of the stream of audiovisual information 300 are stored in the memory 225: the first frame 315 and the second information stream 320. In accordance with a further embodiment of the invention, a frame of the first information stream 310 is stored periodically.

When the user has instructed the apparatus 110 to display and reproduce the stored information of the stream of audiovisual information 300 on the display screen 140 and the loudspeaker 150, respectively, the first frame 315 and the second information stream 320 are retrieved from the memory 225 by presentation means 230. The presentation means are adapted to convert audiovisual information into signals which can be directly displayed and reproduced on the display screen 140 (FIG. 1) and the loudspeaker 150 (FIG. 1), respectively. The presentation means 230 comprise, inter alia, a D/A converter.

The presentation means 230 are further adapted to present the first frame 315 repeatedly to the display screen 140 (FIG. 1) via an output channel 251. Meanwhile, the presentation means 230 convert the information of the second information stream 320 into a signal which can be converted into an audio signal by the loudspeaker 150.

In this way, the stored information is displayed as a displayed stream of audiovisual information 340, as shown in FIG. 3C. The displayed stream of audiovisual information 340 comprises a stream of visual information 330 and the second information stream 320. The stream of visual information comprises the first frame 315 whose display is repeated during the display of the information of the second information stream 320.

FIG. 4 shows an embodiment of the method according to the invention by way of a flow chart 400. This embodiment may be used in an apparatus for storing audiovisual information in a memory. A possible embodiment of this apparatus is a personal computer. By definition, this computer has a memory because a personal computer always has a working memory. Many personal computers are also equipped with a hard disk drive on which a stream of audiovisual information can be stored. A further embodiment of this apparatus is a television with a memory, such as a digital television, suitable for displaying streams of audiovisual data which match the DVB standard.

However, it does not detract from the scope of the invention whether this is an analog or a digital television. It neither detracts from the scope of the invention whether the memory of the television is a hard disk drive, a solid-state memory such as flash, SRAM and DRAM, or an optical disc. Notably, new-generation digital televisions comprise considerable quantities of solid-state memory as a working memory. This working memory will not always be used completely and could thus be used as a memory for performing the method according to the invention. The embodiment of the method, shown in the Figure, can of course also be used in the apparatus 110 (FIG. 2).

The flow chart 400 starts from a recording process in a process step 410. The start of the recording process can be programmed in advance in an apparatus performing the method. This programming operation can be performed by means of an EPG (Electronic Program Guide) or another system. A user may alternatively start the recording process manually.

In a process step 420, the content of a stream of audiovisual information to be recorded is subsequently determined.

Subsequently, the content of the stream of audiovisual information is compared with at least a predetermined criterion in a process step 430. In the embodiment shown, this criterion is stored by a user in a memory of the apparatus. This memory may be the previously mentioned memory but it is alternatively possible to store the criterion in a further memory of the apparatus.

If the content of the stream of audiovisual information does not match the predetermined criterion, the full stream of audiovisual information is stored in the memory of the apparatus in a process step 440. The stream of audiovisual information may be limited by a predetermined period of time which is determined or not determined by the user, or by the content of the stream of audiovisual information. This does not detract from the scope of the invention. When the recording of the stream of audiovisual information has been ended in the process step 440, a process step 470 follows, in which the recording process is ended.

However, if the content of the stream of audiovisual information appears to match the predetermined criterion in the process step 430, the first frame of the video information of the stream of audiovisual information is stored in the memory in a process step 450. Subsequently, the audio information of the stream of audiovisual information is stored in the memory in a process step 460.

In the presented embodiment of the method according to the invention, the process steps 450 and 460 are performed serially. In a further embodiment, the process steps 450 and 460 are performed in parallel.

When the recording of the stream of audiovisual information has been ended in the process step 460, the process step 470 follows, in which the recording process is ended.

The instant of determining when the recording process must be ended is beyond the scope of the invention. Moreover, those skilled in the art will be familiar with many methods of determining this, such as using PDC (Program Delivery Control) or EPG. Moreover, it is also possible to store the duration of a stream of audiovisual information to be recorded in the memory of the apparatus by means of the predetermined criteria.

In the embodiment of the invention presented so far, the first frame of the video information of the stream of audiovisual information is stored in the memory, in addition to the audio information of the stream of audiovisual information, whenever the content of a stream of audiovisual information to be stored in a memory matches at least one predetermined criterion. In a further embodiment of the invention, the process step 450 of the flow chart 400 in FIG. 4 is skipped and no video information of the stream of audiovisual information is stored. During reproduction of the stored audio data, no video data is displayed. Instead, a user may retrieve, for example, information via teletext or another interactive data service.

In yet a further embodiment of the method according to the invention, an image of the stream of audiovisual information is periodically stored during the recording process. This is shown in FIG. 5.

FIG. 5 shows a further embodiment of the method according to the invention by means of a flow chart 500.

The flow chart 500 starts from a recording process in a process step 510. In a process step 520, the content of a stream of audiovisual information to be recorded is subsequently determined.

Subsequently, the content of the stream of audiovisual information is compared with at least one predetermined criterion in a process step 530. In the presented embodiment, this criterion is stored by a user in a memory of the apparatus.

If the content of the stream of audiovisual information does not match the predetermined criterion, the full stream of audiovisual information is stored as a whole in the memory of the apparatus in a process step 540. The stream of audiovisual information may be limited by a predetermined period of time which is determined or not determined by the user, or by the content of the stream of audiovisual information. This does not detract from the scope of the invention. When the recording of the stream of audiovisual information has been ended in the process step 540, a process step 570 follows, in which the recording process is ended.

However, if the content of the stream of audiovisual information appears to match the predetermined criterion in the process step 530, a frame of the video information of the stream of audiovisual information is periodically stored in the memory in a process step 550. The period between storage of a frame can be adjusted by a user. Parallel to the process step 550, the audio information of the stream of audiovisual information is stored in the memory in a process step 560. When the recording of the stream of audiovisual information has been ended in process steps 550 and 560, a process step 570 follows, in which the recording process is ended.

In a further embodiment of the invention, a frame is stored if there are abrupt transitions in the stream of audiovisual information. This may happen when the volume of the sound changes abruptly, for example from high to low. Moreover, transitions in the visual information may be triggers for storing a frame, for example, a change of scenes. A change of scenes may be detected, for example, by comparing consecutive frames with each other. If the difference between two frames is larger than a predetermined minimum, the second frame is stored.

As has been stated hereinbefore, the method according to the invention may also be performed on a personal computer. FIG. 6 shows a diskette 610 as an embodiment of the record carrier according to the invention, comprising instructions which can be carried out by a processor and enable it to perform the method according to the invention. Further embodiments of the record carrier according to the invention are an optical disc, a flash memory or a hard disk, coupled to a wide-area network such as the Internet. This does not detract from the scope of the invention.

The diskette 610 may be used in a computer 620. The computer 620 comprises a disk drive 621 for reading instructions on the diskette 610 by means of the processor. Moreover, the computer 620 comprises a processor 622 for performing the instructions read by the disk drive 621, which instructions enable the processor to perform the method according to the invention by means of a signal-processing circuit 623.

The signal-processing circuit 623 comprises a TV tuner insert card which is known per se. The TV tuner insert card converts an RF television signal coming in via an input channel 625 into a digital stream of audiovisual information, for example, in accordance with the MPEG-2 standard. The digital stream of audiovisual information is further processed by the signal processing circuit 623 by means of the method according to the invention and, if so determined by the method according to the invention, stored in a memory 624.

In summary, the invention relates to a method of splitting up a stream of audiovisual data into a stream of audio data and a stream of video data and of storing at least the audio data when the content of the stream of audiovisual data matches at least one criterion. The reason for this is that, for example, certain television programs may very well be stored with audio data only. A good example is a talk show but it may also apply to music programs. For the sake of additional information, one or few frames of video information may be stored as well so as to provide a user, during reproduction of the audio data, with additional information on, for example, the faces of the guests in the talk show.

1. A method of storing a stream of audiovisual data in a memory, the method comprising the steps of:
a) determining the content of the stream of audiovisual data; and
b) determining whether the content of the stream of audiovisual data matches at least one predetermined criterion;
characterized in that, if the content of the stream of audiovisual data matches the predetermined criterion, the method further comprises the steps of:
c) separating the audio data and video data in the stream of audiovisual data;
d) storing at least a substantial part of the audio data of the stream of audiovisual data; and
e) storing at most a part of the video signal.

2. A method as claimed in claim 1, characterized in that the method further comprises the step of storing a part of the video data of the stream of audiovisual data, in which the stored part is substantially smaller than the complete video component of the stream of audiovisual data.

3. A method as claimed in claim 2, in which the video component of the stream of audiovisual data is built up of frames, characterized in that the step of storing a part of the video data comprises the step of periodically storing a frame.

4. A method as claimed in claim 2, in which the video component of the stream of audiovisual data is built up of frames, characterized in that the step of storing a part of the video data comprises the step of storing the first frame of the stream of audiovisual data.

5. A method as claimed in claim 2, in which the video component of the stream of audiovisual data is built up of frames, characterized in that the step of storing a part of the video data comprises the sub-steps of:
a) determining a characteristic feature of a first part of the stream of audiovisual data;
b) determining a characteristic feature of a second part of the stream of audiovisual data;
c) determining the difference between the characteristic feature of the first part and the characteristic feature of the second part; and,
d) if the difference is larger than a predetermined minimum, storing a frame of the first part of the stream of audiovisual data.

6. A method as claimed in claim 5, characterized in that the characteristic feature is the sound level of the stream of audiovisual data.

7. A method as claimed in claim 1, characterized in that the stream of audiovisual information is a TV program and the criterion is the genre of the TV program.

8. An apparatus adapted to store at least a part of a stream of audiovisual data in a memory, the apparatus being further adapted to
determine the content of the stream of audiovisual data; and
determine whether the content of the stream of audiovisual data matches at least one predetermined criterion;
characterized in that the apparatus is further adapted to separate the audio data and video data in the stream of audiovisual data and comprises a memory for storing at least a substantial part of the audio data of the stream of audiovisual data if the content of the stream of audiovisual data matches the predetermined criterion.

9. An apparatus as claimed in claim 8, characterized in that the apparatus is a digital television and the memory is a working memory.

10. A record carrier comprising instructions which can be carried out by a processor, characterized in that the instructions enable the processor to perform the method as claimed in claim 1.
